(19) United States
(12) Patent Application Publication
(10) Pub. No.: US 2005/0152497 A1
(43) Pub. Date: Jul. 14, 2005

(54) X-ray diffractometer

(75) Inventor: Roger Durst, Madison, WI (US)

Correspondence Address: OLIFF & BERRIDGE, PLC, P.O. BOX 19928, ALEXANDRIA, VA, 22320, US

(73) Assignee: BRUKER AXS K.K., Tsukuba-shi (JP)

(21) Appl. No.: 10/967,288

(22) Filed: Oct. 19, 2004

(30) Foreign Application Priority Data
Oct. 23, 2003 (JP) 2003-362826

(51) Int. Cl. G01N 23/20

(52) U.S. Cl. 378/71

(57) ABSTRACT

In an X-ray diffractometer that reads an X-ray diffraction image by storing and recording the image on a stimulable phosphor, it is possible to realize higher speed of a series of process operations of exposure—read—erase relatively easily and also realize simplification and a small size of a constitution of the diffractometer. The X-ray diffractometer stores and records an X-ray diffraction image on an imaging plate 40 formed of a stimulable phosphor. The imaging plate 40 is installed on a predetermined exposure stage, an eraser 60 is installed behind the imaging plate 40, and a Tear side of an area where the image is stored and recorded is made light transmissive. Whereby, the eraser 60 conducts erasing operation in the area where the image is stored and recorded by irradiating a rear surface of the imaging plate 40 with an erasing light.

### BACKGROUND OF THE INVENTION

1. Field of the Invention

The present invention relates to an X-ray diffractometer that reads an X-ray diffraction image from a sample to be inspected by storing and recording the image on a stimulable phosphor.

2. Description of the Related Art

An X-ray diffractometer uses an optical recording medium (photoreceptor) such as a photosensitive film or a phosphor plate in order to obtain an X-ray diffraction image from a sample. An X-ray diffractometer using an imaging plate (IP) made of a stimulable phosphor as its recording medium has been conventionally provided (for example, refer to Patent document 1).

FIG. 4A to FIG. 4C show a rough structure of the conventional X-ray diffractometer in different operational states. This X-ray diffractometer includes: an incident X-ray generator 10 irradiating a sample (a sample or a microscopic area on the sample) 30 with a collimated X-ray (Xo); a sample support mechanism 20 supporting the sample 30 on an optical path of the incident X-ray (Xo) generated by the incident X-ray generator 10; an imaging plate 45 storing and recording an X-ray diffraction image (Xn) from the sample 30 on a stimulable phosphor; a reader 50 reading the stored and recorded image on the imaging plate 45 by stimulated luminescence caused by irradiation of excitation light; and an eraser 60 erasing the stored and recorded image by irradiating the imaging plate 45 with an erasing light (Le). For the sample support mechanism 20, a so-called goniometer is used. As the imaging plate 45, one formed by a stimulable phosphor sheet 46a laminated on a plate-shaped supporting body 47 is used. The reader 50, which is of a line-sensor type, reads a two-dimensional image by moving in a subscan direction while reading line images in a main scan direction.

In FIG. 4A to FIG. 4C, FIG. 4A shows a state when the X-ray diffraction image (Xn) from the sample 30 is stored and recorded on the stimulable phosphor sheet 46 (exposure process). FIG. 4B shows a state when the stored and recorded image is read by the reader 50 (read process). The reader 50 scan-moves on a recording surface of the phosphor sheet 46 for reading. FIG. 4C shows a state when the stored and recorded image remaining on the phosphor sheet 46 is erased (erase process). In this erase process, the imaging plate 45 is moved to the position of the eraser 60 (erase stage). After the erase process, the imaging plate 45 is returned to the state shown in FIG. 4A for getting ready for recording a subsequent X-ray diffraction image.

FIG. 5 is a flowchart of a cycle of a series of the above-described processes (exposure—read—erase). The main operations of the X-ray diffractometer can be automated by a controlling unit, which uses, for example, a microcomputer, subsequently executing the process cycle (S21 to S25) shown in the drawing.

[Patent document 1] Japanese Patent Application Laid-open No. 2002-77548

### SUMMARY OF THE INVENTION

It is necessary to install the eraser 60 of the aforesaid X-ray diffractometer so as not to obstruct the operation of storing and recording the X-ray diffraction image (Xn) on the imaging plate 45 and the operation of reading the stored and recorded image on the imaging plate 45 by the reader 50. Therefore, the X-ray diffractometer has to be structured such that the eraser 60 is installed at a distant place so as not to interfere with the imaging plate 45 at the time of recording and reading and the imaging plate 45 is moved to the installation place (erase stage) of the eraser 60 only at the time of the erase process.

As a result, as shown in FIG. 5, the conventional X-ray diffractometer described above requires, prior to the erase process (S24) after the read process (S22), a process of moving the imaging plate (IP) to the erase stage where the eraser 60 is installed (S23). A process of moving the imaging plate back to its original exposure stage (S25) is also necessary after the erase process (S24). Since these two moving processes intervene, it is very difficult to speed up a series of the process operations of exposure—read—erase.

Moreover, there is a problem of size increase of the diffractometer because the eraser 60 is installed at a distant place so as not to interfere with the imaging plate 45 at the time of recording and reading. There is another problem that the configuration of the diffractometer becomes complicated due to a need for a mechanism for moving the imaging plate 45.

The present invention was provided in view of the above-described problems, and an object of the present invention is to provide an X-ray diffractometer capable of realizing higher speed of a series of the process operations of exposure—read—erase described above relatively easily and also realizing simplification and a small size of a constitution of the diffractometer.

The present invention provides an X-ray diffractometer comprising:
an incident X-ray generator for generating a collimated X-ray and irradiating a sample with the collimated X-ray thus generated;
a sample support mechanism for supporting the sample on an optical path of the incident X-ray thus generated by the incident X-ray generator;
an imaging plate for storing and recording an X-ray diffraction image from the sample by exposing the X-ray diffraction image on a stimulable phosphor;
a reader for reading the stored and recorded image on the imaging plate by stimulated luminescence caused by irradiation of excitation light; and
an eraser for erasing the stored and recorded image by irradiating the imaging plate with an erasing light,
the X-ray diffractometer comprising:
exposing the X-ray diffraction image;
reading the stored and recorded image; and
erasing the stored and recorded image, in this order,
wherein the imaging plate is installed on a predetermined exposure stage, the eraser is installed behind the imaging plate, and a rear side of an area where the image is stored and recorded is made light transmissive, and erasing operation is thereby conducted by irradiating a rear surface of the imaging plate with the erasing light.

In the above-described invention, the imaging plate is formed by a stimulable phosphor sheet laminated on a plate-shaped supporting body, and at least the supporting body part laminated with the stimulable phosphor sheet is made light-transmissive.

The eraser preferably forms a surface emitter that simultaneously irradiates the entire rear surface of the area where the image of the imaging plate is stored and recorded with the erasing light. The eraser can be constituted of a plurality of emitters arranged along the rear surface of the imaging plate.

In an X-ray diffractometer that reads an X-ray diffraction image by storing and recording the image on a stimulable phosphor, it is possible to realize higher speed of a series of process operations of exposure—read—erase relatively easily and also realize simplification and a small size of the constitution of the diffractometer.

### BRIEF DESCRIPTION OF THE DRAWINGS

FIG. 1A and FIG. 1B are a perspective view and a cross-sectional view schematically showing essential parts of an X-ray diffractometer according to the present invention;

FIG. 2A to FIG. 2C are top views respectively showing states of different operation processes of the X-ray diffractometer shown in FIG. 1A and FIG. 1B;

FIG. 3 is a flowchart showing operation processes of the X-ray diffractometer according to the present invention;

FIG. 4A to FIG. 4C are top views showing a rough structure and operation processes of a conventional X-ray diffractometer; and

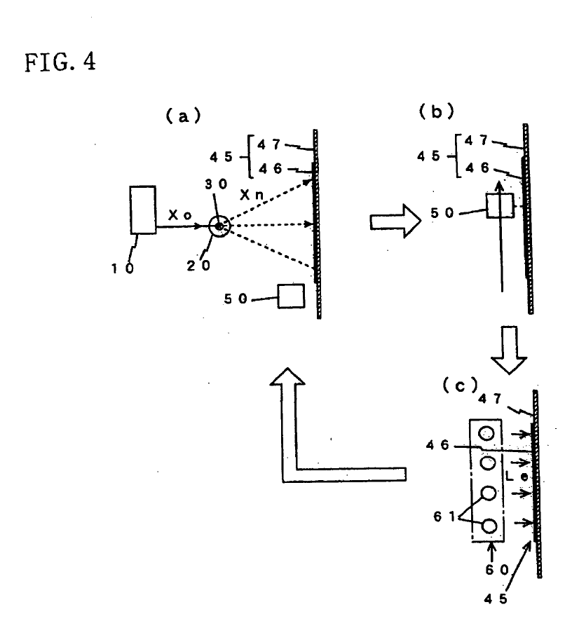

FIG. 5 is a flowchart showing operation processes of the conventional X-ray diffractometer.

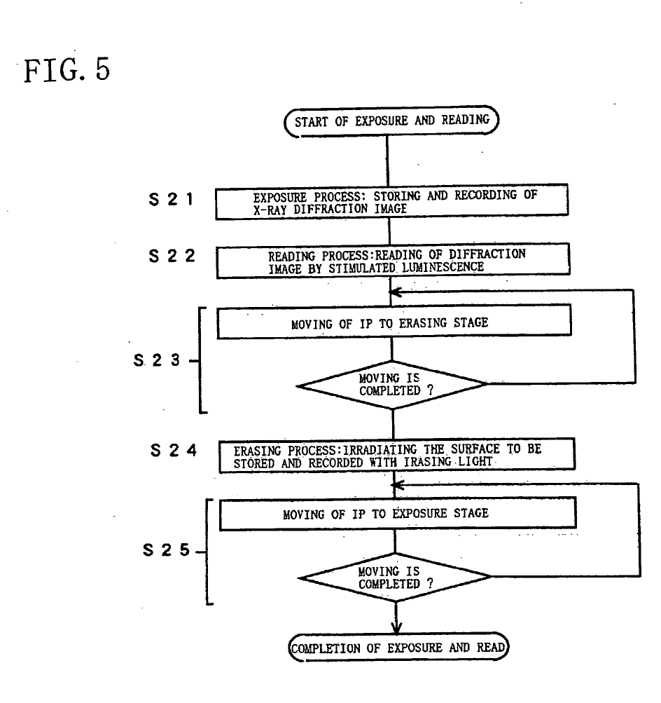

### DETAILED DESCRIPTION OF THE PREFERRED EMBODIMENT

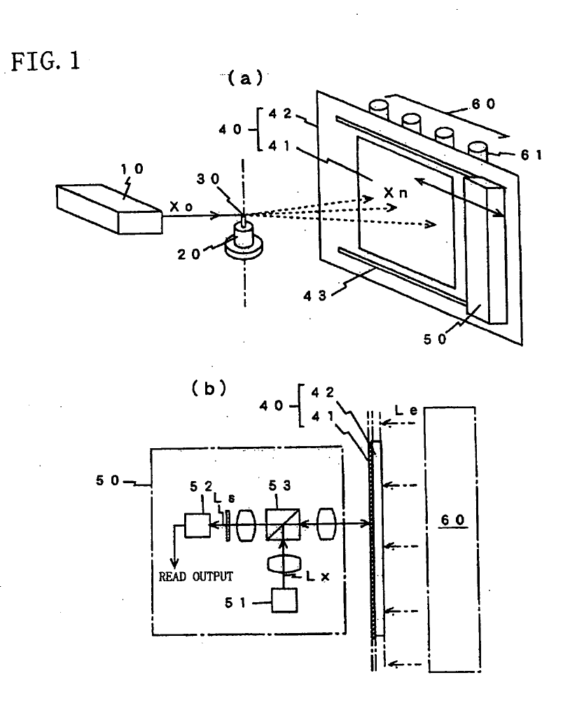

FIG. 1A and FIG. 1B show an embodiment in essential parts of an X-ray diffractometer according to the present invention. In the drawings, FIG. 1A is a perspective view showing a rough structure of the entire X-ray diffractometer and FIG. 1B is a cross-sectional view schematically showing a rough structure of a reader.

The X-ray diffractometer includes as its essential parts an incident X-ray generator 10, a sample support mechanism 20, an imaging plate 40, a reader 50, and an eraser 60 as shown in FIG. 1A.

The incident X-ray generator 10, which includes an X-ray source and a collimator, irradiates a sample (a sample or a microscopic area on the sample) 30 with a collimated X-ray (Xo). The sample support mechanism 20 supports the sample 30 on an optical path of the incident X-ray (Xo) generated by the incident X-ray generator 10. A goniometer is used for this sample support mechanism 20.

The imaging plate 40 is installed on an exposure stage where an X-ray diffraction image (Xn) from the sample 30 is exposed. The X-ray diffraction image (Xn) exposed on this exposure stage is stored and recorded on a stimulable phosphor. The imaging plate 40 is formed by a stimulable phosphor sheet 41 laminated on a plate-shaped supporting body 42. A light transmissive substrate is respectively used for the plate-shaped supporting body 42 (transparent or translucent).

Note that the relative positional relation between the imaging plate 40 and the sample 30 is variably set in an appropriate manner by adjusting the support position of the sample 30 on the sample support mechanism 20, and if necessary, by adjusting the position of the imaging plate 40 in the exposure stage.

The reader 50 reads the stored and recorded image on the imaging plate 40 by stimulated luminescence caused by irradiation of excitation light. The reader 50, which is of a line-sensor type, causes stimulated luminescence of the stored and recorded image on the imaging plate 40 to read the image by a line sensor that reads line images in a main scan direction while moving in a subscan direction (in a direction shown by the arrow in the drawing) perpendicular to the main scan direction, i.e., by a so-called X-Y biaxial scan. A read optical system thereof includes an excitation light source 51, a stimulated luminescence receiving part 52, a beam splitter 53, and so on as shown in FIG. 1B.

An excitation light Lx in a beam form is emitted from the excitation light source 51. A read scan point on the imaging plate 40 is irradiated with this excitation light Lx which has passed through the beam splitter 53. A stimulated luminescence Ls excited by this irradiation enters the stimulated luminescence receiving part 52 via the beam splitter 53 to be detected (photoelectrically converted). A filter for filtering out the stimulated luminescence Ls from the excitation light Lx is provided on an incident optical axis of the stimulated luminescence receiving part 52.

As described above, reading by the reader 50 is performed in a planar manner by the biaxial scan of the main scan and the subscan (biaxial scan in the X and Y axis directions). In this case, the main scan (line read scan) is performed in the reader 50, but the subscan is performed by the movement of the reader 50. The supporting body 42 of the imaging plate 40 has a guide 43 for guiding this movement in the subscan direction (the direction shown by the arrow in the drawing perpendicular to the main scan direction).

The eraser 60 irradiates the imaging plate 40 with erasing lights Le to erase the stored and recorded image. This eraser 60 is fixedly installed behind the imaging plate 40. A front surface of the imaging plate 40 is a recording surface on which the X-ray diffraction image (Xn) is incident, and the eraser 60 is arranged so that it irradiates an opposite (rear) surface of the recording surface with the erasing lights Le.

The stimulable phosphor sheet 41 is irradiated with the erasing lights Le which has been emitted on the rear surface of the imaging plate 40 and has transmitted through the supporting body 42. This irradiation erases the stored and recorded image remaining on the stimulable phosphor sheet 41. In order to realize the erasure by the rear surface irradiation, at least the supporting body 42 part laminated with the stimulable phosphor sheet 41 is made light transmissive.

The eraser 60 is constituted of a plurality of emitters 61 arranged along the rear surface of the imaging plate 40. An array of the emitters 61 forms a surface emitter that simultaneously irradiates the entire rear surface of the storing and recording area of the imaging plate 40 with the erasing lights.

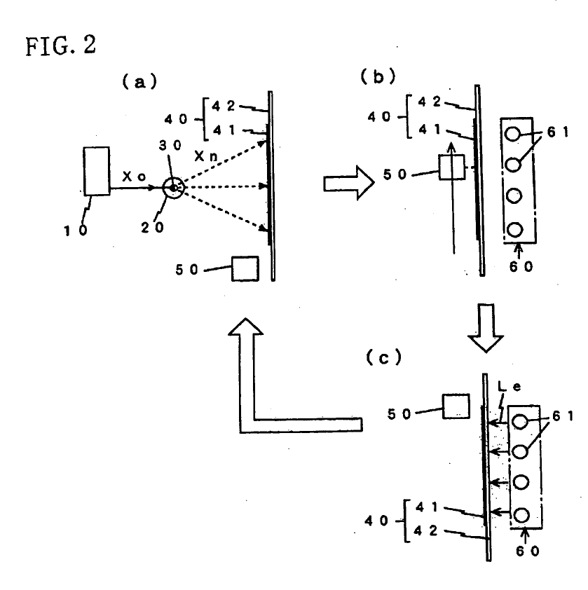

FIG. 2A to FIG. 2C show states of different operation processes of the X-ray diffractometer. In these drawings, FIG. 2A shows a state when the X-ray diffraction image (Xn) from the sample 30 is stored and recorded on the stimulable phosphor sheet 41 (exposure process). FIG. 2B shows a state when the stored and recorded image is read by the reader 50 (read process). The reader 50 scans the recording surface of the phosphor sheet 41 in biaxial directions for reading. FIG. 2C shows a state when the recorded image remaining on the phosphor sheet 41 is erased (erase process).

In the erase process, the array of the emitters 61 of the eraser 60 positioned behind the imaging plate 40 is all lighted simultaneously while the imaging plate 40 is kept fixed on the same stage where it is placed at the time of the exposure and read processes, i.e., while the imaging plate 40 is kept positioned on an exposure stage. The erasing lights from the array of the emitters 61 are incident on the stimulable phosphor sheet 41 through the supporting body 42. Consequently, the stored and recorded image remaining on the stimulable phosphor sheet 41 is erased. After this erase process, the imaging plate 40 becomes in the state shown in FIG. 2A in which it is ready for recording a subsequent X-ray diffraction image while being kept at the same position.

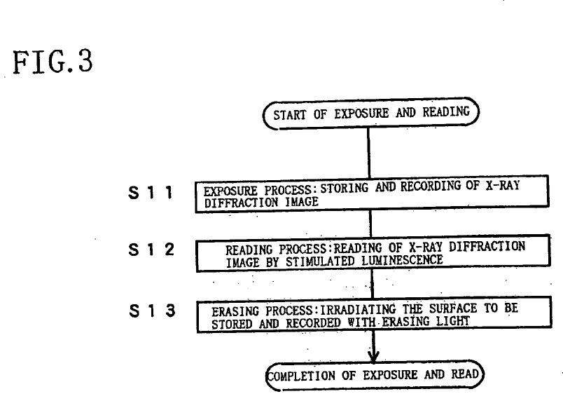

FIG. 3 shows a flowchart of a cycle of a series of the processes described above (exposure—read—erase). As shown in the drawing, the X-ray diffractometer is capable of continuously executing an exposure process (S11), a read process (S12), and an erase process (S13) in sequence without moving the imaging plate 40 from the predetermined exposure stage. This can relatively easily realize higher speed of a series of the process operations of exposure—read—erase.

Further, the eraser 60 can be installed behind the imaging plate 40 and need not be moved to a different position for erasing. This can achieve simplification and a small size of the constitution of the diffractometer. Moreover, the eraser 60 forms a surface emitter that simultaneously irradiates the entire rear surface of the storing and recording area of the imaging plate 40 with the erasing lights, so that the time required for the erase process (S13) can be greatly shortened. This can realize still higher speed of a series of the process operations described above.

In an X-ray diffractometer that reads an X-ray diffraction image by storing and recording the image on a stimulable phosphor, it is possible to realize higher speed of a series of process operations of exposure—read—erase relatively easily and also realize simplification and a small size of the constitution of the diffractometer.

1. An X-ray diffractometer, comprising:
an incident X-ray generator for generating a collimated X-ray and irradiating a sample with the collimated X-ray thus generated;
a sample support mechanism for supporting the sample on an optical path of the incident X-ray generated by said incident X-ray generator;
an imaging plate for storing and recording the X-ray diffraction image from the sample by exposing the X-ray diffraction image on a stimulable phosphor;
a reader for reading the stored and recorded image on said imaging plate by stimulated luminescence caused by irradiation of excitation light; and
an eraser for erasing the stored and recorded image by irradiating said imaging plate with an erasing light, said X-ray diffractometer comprising:
exposing the X-ray diffraction image:
reading the stored and recorded image; and
erasing the stored and recorded image, in this order,
wherein said imaging plate is installed on a predetermined exposure stage, said eraser is installed behind said imaging plate, and a rear side of an area where the image is stored and recorded is made light transmissive, and erasing operation is thereby conducted by irradiating a rear surface of said imaging plate with the erasing light.

2. The X-ray diffractometer according to claim 1, wherein said imaging plate is formed by a stimulable phosphor sheet laminated on a plate-shaped supporting body and at least the supporting body part laminated with the stimulable phosphor sheet is made light transmissive.

3. The X-ray diffractometer according to claim 1, wherein said eraser forms a surface emitter that simultaneously irradiates the entire rear surface of the area where the image of the imaging plate is stored and recorded with the erasing light.

4. The X-ray diffractometer according to claim 1, wherein said eraser is constituted of a plurality of emitters arranged along the rear surface of said imaging plate.

5. The X-ray diffractometer according to claim 2, wherein said eraser forms a surface emitter that simultaneously irradiates the entire rear surface of the area where the image of the imaging plate is stored and recorded with the erasing light.

6. The X-ray diffractometer according to claim 2, wherein said eraser is constituted of a plurality of emitters arranged along the rear surface of said imaging plate.

7. The X-ray diffractometer according to claim 3, wherein said eraser is constituted of a plurality of emitters arranged along the rear surface of said imaging plate.
